(19) United States
(12) Patent Application Publication
(10) Pub. No.: US 2005/0273304 A1
(43) Pub. Date: Dec. 8, 2005

(54) Methods for evaluating and improving drilling operations

(75) Inventors: Stuart Oliver, Magnolia, TX (US); Sujian Huang, Beijing (CN); Luis C. Paez, Houston, TX (US); Halle Aslaksen, Neu Isenburg (DE)

Correspondence Address: OSHA LIANG L.L.P., 1221 MCKINNEY STREET, SUITE 2800, HOUSTON, TX, 77010, US

(73) Assignee: Smith International, Inc., Houston, TX (US)

(21) Appl. No.: 11/137,713

(22) Filed: May 25, 2005

Related U.S. Application Data
(63) Continuation-in-part of application No. 09/635,116, filed on Aug. 9, 2000, now Pat. No. 6,873,947.
(63) Continuation-in-part of application No. 10/749,019, filed on Dec. 29, 2003.
Application No. 10/749,019 is a continuation of application No. 09/524,088, filed on Mar. 13, 2000, now Pat. No. 6,516,293.
(63) Continuation-in-part of application No. 10/852,574, filed on May 24, 2004.
(63) Continuation-in-part of application No. 10/851,677, filed on May 21, 2004.
Application No. 10/851,677 is a continuation-in-part of application No. 09/689,299, filed on Oct. 11, 2000, now Pat. No. 6,785,641.
(63) Continuation-in-part of application No. 10/888,358, filed on Jul. 9, 2004.
Application No. 09/635,116 is a continuation of application No. 09/524,088, filed on Mar. 13, 2000, now Pat. No. 6,516,293.
(63) Continuation-in-part of application No. 10/888,446, filed on Jul. 9, 2004.
(60) Provisional application No. 60/485,642, filed on Jul. 9, 2003.

(51) Int. Cl. G06G 7/48

(52) U.S. Cl. 703/10

(57) ABSTRACT

Methods and computer systems for performing and using drilling simulations. The drilling simulations can be used to improve drilling performance or demonstrate drilling performance of a drilling profile. One method for creating a drilling profile includes obtaining drilling profile data and performing a drilling simulation using at least a portion of the drilling profile data. Modifications are then recommended for the drilling profile data.

### CROSS-REFERENCE TO RELATED APPLICATIONS

This application claims the benefit, pursuant to 35 U.S.C. § 120, as a continuation-in-part application of U.S. patent application Ser. No. 09/524,088 (now U.S. Pat. No. 6,516,293), Ser. No. 09/635,116 (now U.S. Pat. No. 6,873,947), Ser. Nos. 10/749,019, 09/689,299 (now U.S. Pat. No. 6,785,641), Ser. Nos. 10/852,574, 10/851,677, 10/888,358, and 10/888,446, all of which are expressly incorporated by reference in their entirety.

### BACKGROUND OF INVENTION

FIG. 1 shows one example of a conventional drilling system for drilling an earth formation. The drilling system includes a drilling rig 10 used to turn a drilling tool assembly 12 that extends downward into a well bore 14. The drilling tool assembly 12 includes a drilling string 16, and a bottomhole assembly (BHA) 18, which is attached to the distal end of the drill string 16. The “distal end” of the drill string is the end furthest from the drilling rig.

The drill string 16 includes several joints of drill pipe 16a connected end to end through tool joints 16b. The drill string 16 is used to transmit drilling fluid (through its hollow core) and to transmit rotational power from the drill rig 10 to the BHA 18. In some cases the drill string 16 further includes additional components such as subs, pup joints, etc.

The BHA 18 includes at least a drill bit 20. Typical BHA's may also include additional components attached between the drill string 16 and the drill bit 20. Examples of additional BHA components include drill collars, stabilizers, measurement-while-drilling (MWD) tools, logging-while-drilling (LWD) tools, subs, hole enlargement devices (e.g., hole openers and reamers), jars, accelerators, thrusters, downhole motors, and rotary steerable systems.

In general, drilling tool assemblies 12 may include other drilling components and accessories, such as special valves, such as kelly cocks, blowout preventers, and safety valves. The drill bit 20 in the BHA 18 may be any type of drill bit suitable for drilling earth formation. Two common types of drill bits used for drilling earth formations are fixed-cutter (or fixed-head) bits and roller cone bits. FIG. 2 shows one example of a fixed-cutter bit. FIG. 3 shows one example of a roller cone bit.

Referring to FIG. 2, fixed-cutter bits (also called drag bits) 21 typically comprise a bit body 22 having a threaded connection at one end 24 and a cutting head 26 formed at the other end. The head 26 of the fixed-cutter bit 21 typically includes a plurality of ribs or blades 28 arranged about the rotational axis of the drill bit and extending radially outward from the bit body 22. Cutting elements 29 are embedded in the raised ribs 28 to cut formation as the drill bit is rotated on a bottom surface of a well bore. Cutting elements 29 of fixed-cutter bits typically comprise polycrystalline diamond compacts (PDC) or specially manufactured diamond cutters. These drill bits are also referred to as PDC bits.

Referring to FIG. 3, roller cone bits 30 typically comprise a bit body 32 having a threaded connection at one end 34 and one or more legs (typically three) extending from the other end. A roller cone 36 is mounted on each leg and is able to rotate with respect to the bit body 32. On each cone 36 of the drill bit 30 are a plurality of cutting elements 38, typically arranged in rows about the surface of the cone 36 to contact and cut through formation encountered by the drill bit. Roller cone bits 30 are designed such that as a drill bit rotates, the cones 36 of the roller cone bit 30 roll on the bottom surface of the well bore (called the “bottomhole”) and the cutting elements 38 scrape and crush the formation beneath them. In some cases, the cutting elements 38 on the roller cone bit 30 comprise milled steel teeth formed on the surface of the cones 36. In other cases, the cutting elements 38 comprise inserts embedded in the cones. Typically, these inserts are tungsten carbide inserts or polycrystalline diamond compacts. In some cases hardfacing is applied to the surface of the cutting elements and/or cones to improve wear resistance of the cutting structure.

For a drill bit 20 to drill through formation, sufficient rotational moment and axial force must be applied to the drill bit 20 to cause the cutting elements of the drill bit 20 to cut into and/or crush formation as the drill bit is rotated. The axial force applied on the drill bit 20 is typically referred to as the “weight on bit” (WOB). The rotational moment applied to the drilling tool assembly 12 at the drill rig 10 (usually by a rotary table or a top drive mechanism) to turn the drilling tool assembly 12 is referred to as the “rotary torque”. The speed at which the rotary table rotates the drilling tool assembly 12, typically measured in revolutions per minute (RPM), is referred to as the “rotary speed”. Additionally, the portion of the weight of the drilling tool assembly supported at the rig 10 by the suspending mechanism (or hook) is typically referred to as the hook load.

During drilling, the actual WOB is not constant. Some of the fluctuation in the force applied to the drill bit may be the result of the drill bit contacting with formation having harder and softer portions that break unevenly. However, in most cases, the majority of the fluctuation in the WOB can be attributed to drilling tool assembly vibrations. Drilling tool assemblies can extend more than a mile in length while being less than a foot in diameter. As a result, these assemblies are relatively flexible along their length and may vibrate when driven rotationally by the rotary table. Drilling tool assembly vibrations may also result from vibration of the drill bit during drilling. Several modes of vibration are possible for drilling tool assemblies. In general, drilling tool assemblies may experience torsional, axial, and lateral vibrations. Although partial damping of vibration may result due to viscosity of drilling fluid, friction of the drill pipe rubbing against the wall of the well bore, energy absorbed in drilling the formation, and drilling tool assembly impacting with well bore wall, these sources of damping are typically not enough to suppress vibrations completely.

Vibrations of a drilling tool assembly are difficult to predict because different forces may combine to produce the various modes of vibration, and models for simulating the response of an entire drilling tool assembly including a drill bit interacting with formation in a drilling environment have not been available. Drilling tool assembly vibrations are generally undesirable, not only because they are difficult to predict, but also because the vibrations can significantly affect the instantaneous force applied on the drill bit. This can result in the drill bit not operating as expected. For example, vibrations can result in off-centered drilling, slower rates of penetration, excessive wear of the cutting elements, or premature failure of the cutting elements and the drill bit. Lateral vibration of the drilling tool assembly may be a result of radial force imbalances, mass imbalance, and drill bit/formation interaction, among other things. Lateral vibration results in poor drilling tool assembly performance, overgage hole drilling, out-of-round, or “lobed” well bores and premature failure of both the cutting elements and drill bit bearings.

When the drill bit wears out or breaks during drilling, the entire drilling tool assembly must be lifted out of the well bore section-by-section and disassembled in an operation called a “pipe trip”. In this operation, a heavy hoist is required to pull the drilling tool assembly out of the well bore in stages so that each stand of pipe (typically pipe sections of about 90 feet) can be unscrewed and racked for the later re-assembly. Because the length of a drilling tool assembly may extend for more than a mile, pipe trips can take several hours and can pose a significant expense to the well bore operator and drilling budget. Therefore, the ability to design drilling tool assemblies which have increased durability and longevity, for example, by minimizing the wear on the drilling tool assembly due to vibrations, is very important and greatly desired to minimize pipe trips out of the well bore and to more accurately predict the resulting geometry of the well bore drilled.

Some companies offer drilling services for the purposes of improving drilling performance. These services typically include modeling up to around 200 feet of the BHA with representative factors assumed for the influence of the drill string and the drill bit during drilling. The drill string is typically modeled as a spring and the spring constant assumed based on the expected configuration of the drill string. The BHA is typically modeled as a beam suspended from the spring at one end and excited by an excitation at the other end assumed to represent the excitation resulting from a drill bit interacting with the formation.

What is still needed, however, are methods for using drilling simulations to create drilling profiles to efficiently drill a formation of interest.

### SUMMARY OF INVENTION

In one aspect, the present invention relates to a method for creating a drilling profile. The method includes obtaining drilling profile data, performing a drilling simulation using at least a portion of said drilling profile data, and recommending a modification to the drilling profile data.

In one aspect, the present invention relates to a method for creating a drilling profile. The method includes obtaining predicted drilling performance data from a drilling simulation of a base drilling profile and recommending a modification to the base drilling profile using the predicted drilling performance data.

In one aspect, the present invention relates to a method for creating a drilling profile for a planned well. The method includes obtaining field data from a field data source, wherein the field data comprises a base drilling profile and at least one well bore parameter for the planned well and inputting the field data into a drilling simulation source. Drilling performance data is obtained from the drilling simulation source. The method further includes creating a different drilling profile and transferring the different drilling profile to a data source.

In one aspect, the present invention relates to a method for modifying a base drilling profile for a planned well. The method includes obtaining field data from a field data source, wherein the field data comprises the base drilling profile and at least one well bore parameter for the planned well. Field data is input into a drilling simulation source, from which drilling performance data is obtained. The method further includes determining a modification to the base drilling profile and transferring the modification to a data source.

In one aspect, the present invention relates to a method for creating a drilling profile for a planned well. The method includes obtaining drilling profile data, performing a drilling simulation using at least a portion of said drilling profile data, and recommending a modification to said drilling profile data.

In one aspect, the present invention relates to a method for demonstrating predicted drilling performance. The method includes creating a recommended drilling profile, wherein the recommended drilling profile comprises a recommended drilling tool assembly. A drilling simulation is performed using the recommended drilling profile. The method further includes displaying a graphical visualization of at least a portion of the recommended drilling tool assembly in a well bore drilling an earth formation.

In one aspect, the present invention relates to a computer system for improving drilling performance of a drilling tool assembly. The computer system includes a processor, a memory, a storage device, and software instructions stored in the memory. The software instructions enable the computer system under control of the processor to obtain field data from a field data source, wherein the field data comprises a base drilling profile and at least one well bore parameter for the planned well. The software instructions also enable the computer system to input the field data into a drilling simulation source, obtain drilling performance data from the drilling simulation source, create a different drilling profile, and transfer the different drilling profile to the storage device.

In one aspect, the present invention relates to a method for demonstrating drilling performance on a computer graphical interface. The method includes performing a drilling simulation of a drilling profile and displaying a three-dimensional graphical visualization of at least a portion of the drilling tool assembly in a well bore. The three-dimensional graphical visualization includes a drilling performance parameter selected from the group consisting of lateral vibration, axial vibration, torsional vibration, force on a component, rate of penetration, torque, weight on bit, and direction of path drilled.

In one aspect, the present invention relates to a computer system for improving drilling performance of a drilling tool assembly. The computer system includes a processor, a memory, a display, and software instructions stored in the memory. The software instructions enable the computer system under control of the processor to perform a drilling simulation of a drilling profile and display a three-dimensional graphical visualization of at least a portion of the drilling tool assembly in a well bore. The three-dimensional graphical visualization comprises a simulated drilling performance characteristic.

Other aspects and advantages of the invention will be apparent from the following description and the appended claims.

### BRIEF DESCRIPTION OF DRAWINGS

FIG. 1 shows a schematic diagram of a prior art drilling system for drilling earth formations.

FIG. 2 shows a perspective view of a prior art fixed-cutter bit.

FIG. 3 shows a perspective view of a prior art roller cone bit.

FIG. 4 shows a flow chart of a method in accordance with one embodiment of the present invention.

FIG. 5 shows an input screen for a drilling simulation in accordance with one embodiment of the present invention.

FIG. 6 shows an input screen for a drilling simulation in accordance with one embodiment of the present invention.

FIG. 7A shows a graphical visualization of a drilling performance parameter from a drilling simulation in accordance with one embodiment of the present invention.

FIG. 7B shows a graphical visualization of a drilling performance parameter from a drilling simulation in accordance with one embodiment of the present invention

FIG. 8 shows a graphical visualization of a drilling tool assembly in accordance with one embodiment of the present invention.

FIG. 9A shows a graphical visualization of a drilling performance parameter from a drilling simulation in accordance with one embodiment of the present invention.

FIG. 9B shows a graphical visualization of a drilling performance parameter from a drilling simulation in accordance with one embodiment of the present invention.

FIG. 10A shows a graphical visualization of a drilling performance parameter from a drilling simulation in accordance with one embodiment of the present invention.

FIG. 10B shows a graphical visualization of a drilling performance parameter from a drilling simulation in accordance with one embodiment of the present invention.

FIG. 11 shows a computer system on which embodiments of the present invention may be implemented.

FIG. 12 shows a flow chart of a method in accordance with one embodiment of the present invention.

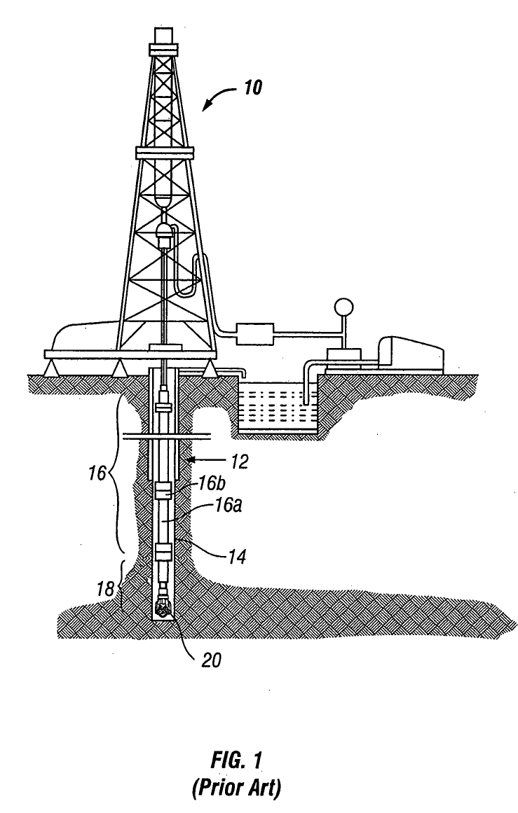

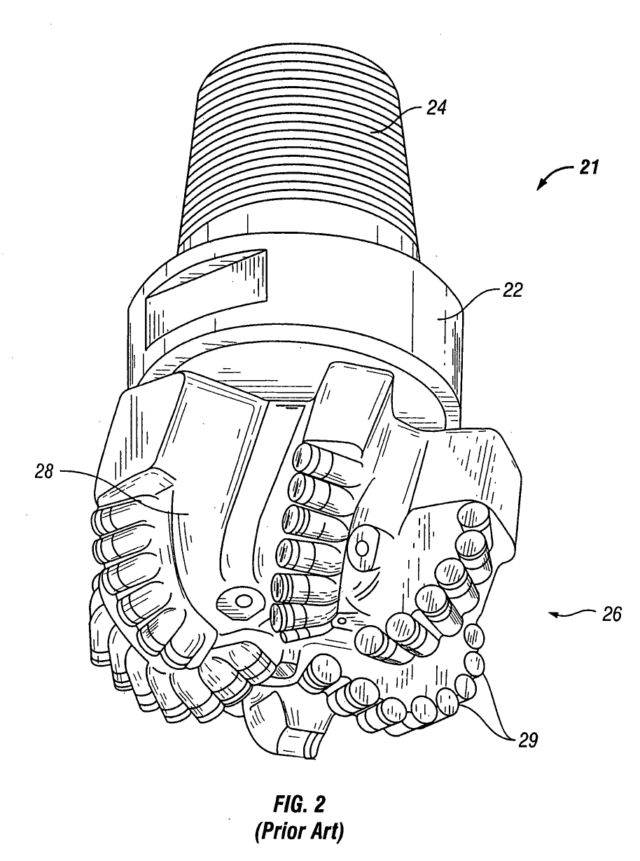

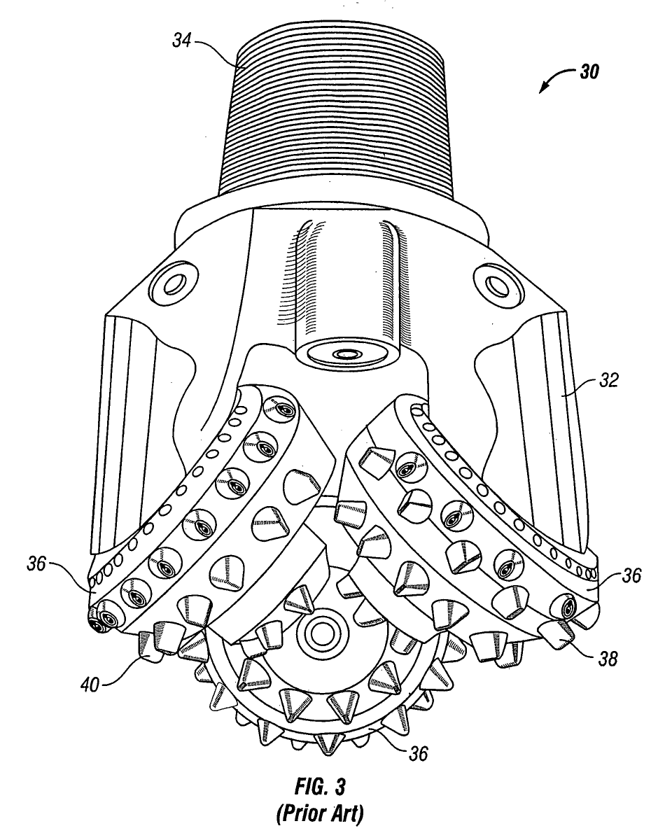

### DETAILED DESCRIPTION

In one aspect, the present invention provides a method for identifying an improvement that can be made to a drilling operation to improve drilling performance. In one embodiment, a method for creating a drilling profile is used to improve drilling performance. In a selected embodiment, the method for creating a drilling profile includes obtaining drilling profile data, performing a drilling simulation, and recommending a modification to the drilling profile data.

“Drilling performance” may be measured by one or more drilling performance parameters. Examples of drilling performance parameters include rate of penetration (ROP), rotary torque required to turn the drilling tool assembly, rotary speed at which the drilling tool assembly is turned, drilling tool assembly lateral, axial, or torsional vibrations induced during drilling, weight on bit (WOB), forces acting on components of the drilling tool assembly, and forces acting on the drill bit and components of the drill bit (e.g., on blades, cones, and/or cutting elements). Drilling performance parameters may also include the inclination angle and azimuth direction of the borehole being drilled. One skilled in the art will appreciate that other drilling performance parameters exist and may be considered without departing from the scope of the invention.

“Obtaining modeled information” means getting modeled information, which may be information that has previously been modeled, or may be information “freshly” generated at or near the time that the other aspects of the invention are being performed. Methods that may be used to generate such modeled information include the methods set forth in U.S. patent application Ser. No. 09/524,088 (now U.S. Pat. No. 6,516,293), Ser. No. 09/635,116 (now U.S. Pat. No. 6,873,947), Ser. Nos. 10/749,019, 09/689,299 (now U.S. Pat. No. 6,785,641), Ser. Nos. 10/852,574, 10/851,677, 10/888,358, 10/888,446, all of which are expressly incorporated by reference in their entirety.

“Drilling characteristic,” as used herein may include one or more of the following, drilling tool assembly design parameters, bit design parameters, and drilling operating parameters.

“Drilling tool assembly design parameters,” may include one or more of the following: the type, location, and number of components included in the drilling tool assembly; the length, ID, OD, weight, and material properties of each component; the type, size, weight, configuration, and material properties of the drilling tool; and the type, size, number, location, orientation, and material properties of the cutting elements on the drilling tool. Material properties in designing a drilling tool assembly may include, for example, the strength, elasticity, and density of the material. It should be understood that drilling tool assembly design parameters may include any other configuration or material parameter of the drilling tool assembly without departing from the scope of the invention.

“Bit design parameters,” which are a subset of drilling tool assembly design parameters, may include one or more of the following: bit type (i.e., fixed or roller cone), size of bit, shape of bit, the cutting structures on the drill bit, such as cutting element geometry, quantity, and locations. As with other component in the drilling tool assembly, the material properties of the drill bit may be defined.

“Drilling operating parameters” may include one or more of the following: the rotary table (or top drive mechanism), speed at which the drilling tool assembly is rotated (RPM), the downhole motor speed (if a downhole motor is included) and the hook load. Drilling operating parameters may further include drilling fluid parameters, such as the viscosity and density of the drilling fluid, for example. It should be understood that drilling operating parameters are not limited to these variables. In other embodiments, drilling operating parameters may include other variables, e.g. rotary torque and drilling fluid flow rate. Additionally, drilling operating parameters for the purpose of drilling simulation may further include the total number of drill bit revolutions to be simulated or the total drilling time desired for drilling simulation. Once the parameters of the system (drilling tool assembly under drilling conditions) are defined, they can be used along with various interaction models to simulate the dynamic response of the drilling tool assembly drilling earth formation as described below.

As used herein, the phrase “drilling profile” means a set of drilling characteristics selected or used for a given formation.

“Well bore parameters” may include one or more of the following: the geometry of a well bore and formation material properties (i.e. geologic characteristics). The trajectory of a well bore in which the drilling tool assembly is to be confined also is defined along with an initial well bore bottom surface geometry. Because the well bore trajectory may be straight, curved, or a combination of straight and curved sections, well bore trajectories, in general, may be defined by defining parameters for each segment of the trajectory. For example, a well bore may be defined as comprising N segments characterized by the length, diameter, inclination angle, and azimuth direction of each segment and an indication of the order of the segments (i.e., first, second, etc.). Well bore parameters defined in this manner can then be used to mathematically produce a model of the entire well bore trajectory. Formation material properties at various depths along the well bore may also be defined and used. One of ordinary skill in the art will appreciate that well bore parameters may include additional properties, such as friction of the walls of the well bore and well bore fluid properties, without departing from the scope of the invention.

As used herein, a “drilling simulation” is a dynamic simulation of a drilling tool assembly drilling an earth formation that takes into account at least one cutting element interacting with the earth formation. The drilling simulation is referred to as being “dynamic” because the drilling is a “transient time simulation,” meaning that it is based on time or the incremental rotation of the drilling tool assembly. A time based drilling simulation is synonymous with a rotation based drilling simulation because a rotational speed of a drilling tool assembly is by definition an increment of rotation divided by an increment of time. Accordingly, the increment of rotation is known if increments of a drilling simulation are measured in increments of time, and vice versa.

Typically, a drilling simulation uses a set of drilling tool assembly design parameters to provide a simulation model for at least a portion of a drilling tool assembly. Drilling operating parameters are used in the drilling simulation for operating the modeled drilling tool assembly, or portion thereof. During a drilling simulation, well bore parameters define the environment in which the drilling tool assembly is operating.

In accordance with one or more embodiments of the invention, a drilling tool assembly includes at least one segment (or joint) of drill pipe and a cutting tool. The components of a drilling tool assembly may be more generally referred to as a drill string and a bottomhole assembly (BHA). The drill string as discussed herein refers to a string of drill pipe, which includes one or more joints of drill pipe. The BHA includes at least one cutting tool.

In a typical drilling tool assembly, the drill string includes several joints of drill pipe connected end to end, and the bottomhole assembly includes one or more drill collars and a drill bit attached to an end of the BHA. The BHA may further include additional components, such as stabilizers, a downhole motor, MWD tools, and LWD tools, subs, hole enlargement devices, jars, accelerators, thrusters, and/or a rotary steerable system, for example. Therefore, in accordance with embodiments of the invention, a drilling tool assembly may be a single segment of drill pipe attached to a drill bit, or as complex as a multi-component drill string that includes a kelly, a lower kelly cock, a kelly saver sub, several joints of drill pipe with tool joints, etc., and a multi-component BHA that includes drill collars, stabilizers, and other additional specialty items (e.g., reamers, valves, MWD tools, mud motors, rotary steerable systems, etc.) and a drill bit.

While the BHA is generally considered to include a drill bit, in the example method discussed below, the detailed interaction of the drill bit with the bottomhole surface during drilling is generally considered separately. This separate consideration of the drill bit in detail allows for the interchangeable use of any drill bit model in the drilling tool assembly simulation as determined by the system designer. Drill bits used and modeled in one or more embodiments of the invention may include, for example, fixed cutter bits, roller cone bits, hybrid bits (bits having a combination of fixed cutters and rolling cutting structure), bi-centered bits, reaming bits, or any other cutting tool used during the drilling of earth formation. One of ordinary skill in the art will appreciate that the drilling simulation method may consider the drill bit jointly with the drilling tool assembly without departing from the scope of the invention.

One example of a method that may be used to simulate a drilling tool assembly in accordance with one or more embodiments of the invention is disclosed in U.S. patent application Ser. No. 09/689,299 entitled “Simulating the Dynamic Response of a Drilling Tool Assembly and its Application to Drilling Tool Assembly Design Optimizing and Drilling Performance Optimization”, which has been incorporated by reference in its entirety. In accordance with this method, properties of the drilling to be simulated are provided as input. The input may include drilling tool assembly design parameters, well bore parameters, and drilling operating parameters.

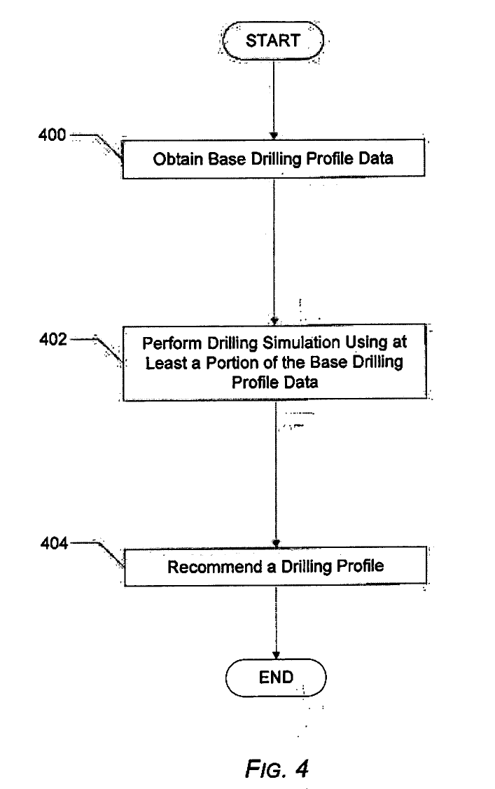

FIG. 4 shows one embodiment of a method that involves the evaluating of drilling information to provide a solution to improve a drilling performance parameter. The method includes obtaining base drilling profile data (step 400). The base drilling profile data may be obtained as a portion of field data from a customer that has planned a well. A drilling simulation is performed using at least a portion of the base drilling profile data (step 402). As noted above, the drilling simulation may be performed using one or more of the methods set forth in U.S. patent application Ser. No. 09/524,088 (now U.S. Pat. No. 6,516,293), Ser. No. 09/635,116 (now U.S. Pat. No. 6,873,947), Ser. Nos. 10/749,019, 09/689,299 (now U.S. Pat. No. 6,785,641), Ser. Nos. 10/852,574, 10/851,677, 10/888,358, and 10/888,446, all of which are expressly incorporated by reference in their entirety.

In a selected embodiment, the drilling simulation is based on a particular formation. In other words, the drilling simulation is tailored to the geologic characteristics of the formation of interest. The geologic characteristics of the formation may be obtained through offset well data, field tests, predictions, or through any other method known in the art. After performing a drilling simulation of a base drilling profile drilling the particular formation, the drilling performance through the formation of interest is predicted (step 402). After the performance is predicted, various criteria may be reviewed, such as rate of penetration, wear, vibration, etc. Based on the prediction, one or more drilling characteristics may be changed. For example, multiple types and/or sizes of bits may be selected. In one embodiment, offset well data may reveal that both hard and soft sections exist in the formation of interest. Thus, the planner may recommend that a roller cone bit be used throughout the hard formation and a fixed cutter bit be used through the soft formation. Similarly, the designer may recommend that multiple designs of roller cone bits may be used throughout the hard sections. In this manner, the overall cost of drilling the well may be significantly reduced. Based on the predicted drilling performance a planner will recommend a different drilling profile (step 404) configured for drilling at least a portion of a planned well. Prior to recommending the different drilling profile, a drilling simulation may be performed using the recommended drilling profile in place of the base drilling profile to predict the drilling performance and recommend further changes to the drilling profile if improved drilling performance may be achieved.

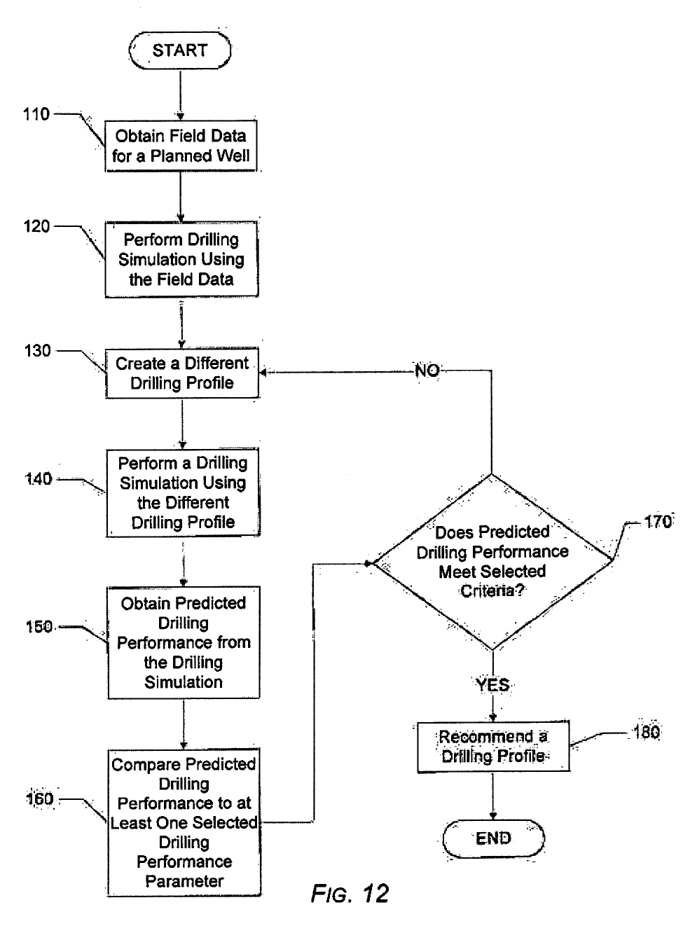

In FIG. 12, a flow chart of an iterative method for recommending a drilling profile in accordance with an embodiment of the present invention is shown. The method shown in FIG. 12 is directed to recommending a drilling profile specific to a planned well. The method includes obtaining field data for a planned well (step 110). A “planned well” refers to a well that has not been drilled, but has most of the planning completed, such as a target formation and a well bore trajectory to reach the target formation from a selected surface location. Field data for the planned well may be obtained from various sources, with the most common source being personnel at a company that is responsible for overseeing the drilling operation. The field data may contain information that is related to the planned well, such as drilling profiles used for offset wells and geologic information for the area in which the well is drilled. The information for the planned well may further include a planned well bore trajectory. To be able to perform a drilling simulation, the field data should include a base drilling profile and geologic characteristics for the formation to be drilled.

After sufficient field data is obtained, a drilling simulation using the field data is performed (step 120). The drilling simulation using the field data may be used to diagnose problems encountered during the drilling of offset wells and identify areas for potential improvement in drilling performance. The results of the drilling simulation also provide a baseline (both qualitative and quantitative) for evaluating other drilling profiles that may be created in accordance with the embodiment. The drilling simulator may also be calibrated by comparing simulated drilling performance to the actual drilling performance of the offset well from which the field data was obtained. Such a comparison may also assure the operator that the drilling simulation is sufficiently accurate.

Drilling performance data obtained from the drilling simulation is used to aid in creating a different drilling profile (step 130). The different drilling profile may be created by adjusting one or more drilling characteristics, or by creating a new drilling profile guided by knowledge gained from the drilling performance data. A drilling simulation using the different drilling profile is performed (step 140), from which a predicted drilling performance of the different drilling profile is obtained (step 150). The predicted drilling performance is then compared to at least one selected drilling performance parameter (step 160). In another embodiment, the predicted drilling performance may be compared to the simulated drilling performance using the base drilling profile. The comparison is then used to determine (step 170) whether to create another drilling profile (130) or to recommend a drilling profile (step 180) substantially the same as the different drilling profile that was created in step 130.

For the purposes of illustration, a specific example in accordance with one embodiment of the present invention will now be described. In this hypothetical situation, a drilling operator has a plan to drill 10 wells in one area of South Texas. During the drilling of the first well, the drilling operator experienced low ROP and short drill bit life while drilling from 5,000 feet to 8,000 feet. The drilling operator wants to improve drilling performance for the remaining wells. In accordance with one embodiment of the invention, an engineer obtains the drilling information from the previous well. The drilling information includes the drilling tool assembly parameters, drilling operating parameters, and well parameters. Because the future wells will be drilled close to the first well, the formation characteristics will be similar. Understanding the poor past drilling performance will allow for improvements in drilling performance in the future wells.

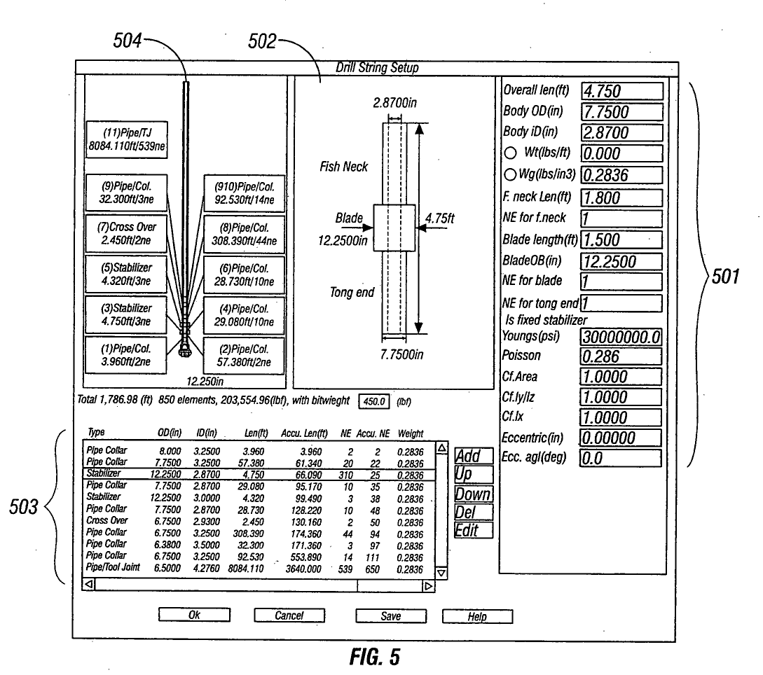

First, the drilling operator provides a drilling engineer with drilling information, which includes the above information. Next, the drilling tool assembly that was used for the first well is modeled. FIG. 5 shows an example input screen used to define components of the drilling tool assembly in accordance with one embodiment of the invention. In FIG. 5, a stabilizer is described by entering dimensions and material properties into the input boxes 501. The component display 502 shows the component that has been described. Other components are also defined. The components are combined to form the drilling tool assembly. In this program, the components in the drilling tool assembly are shown as a component list 503 and as a drilling tool assembly layout 504. The drilling tool assembly will be kept the same between the simulations, except for changing the drill bits.

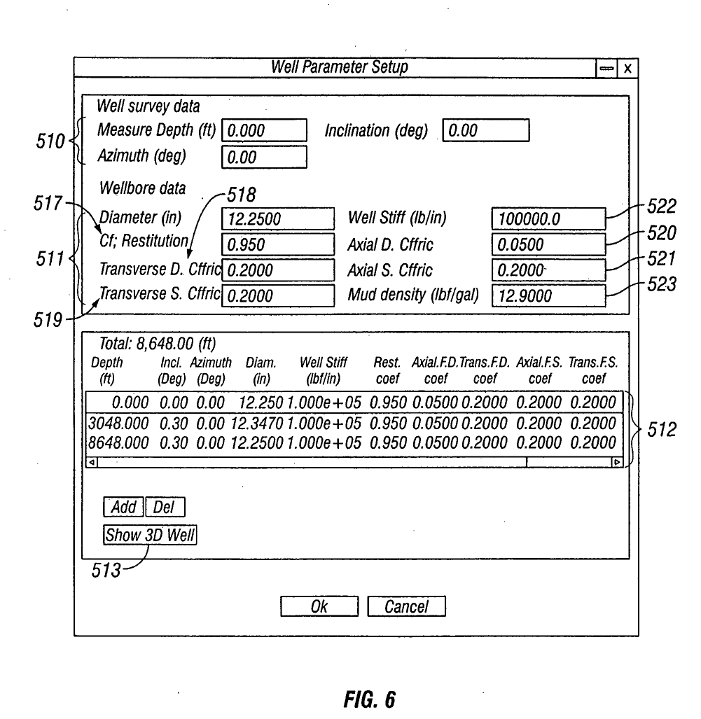

Before the drilling simulation, the well bore environment is also defined. Well logs from the offset well previously drilled by the drilling operator are used to model the well bore for simulation purposes. Well bore parameters are entered into an input screen shown in FIG. 6 in accordance with one embodiment of the invention. The geometry of the well bore is entered into 510 in increments of depth. The particular well being simulated is 7,000 feet in total measured depth. Until 4,000 feet, the well is near vertical. At this point, a build angle of 5 degrees per hundred feet begins until reaching 65 degrees inclination at 5,300 feet total measured depth. The well is nearly straight beyond 5,300 feet. The drilling simulation will occur at 7,000 feet while drilling mudstone having an unconfined compressive strength of 11,000 pounds per square inch.

Other well bore parameters are also entered into the input screen shown in FIG. 6. In this embodiment, the diameter, drilling fluid (mud) density, well stiffness, coefficient of restitution, and coefficients of friction are entered under well bore data 511. Well stiffness 522 is measured in pressure and refers to the mechanical strength of the wall of the well bore. The coefficient of restitution 517 refers to how much energy is dissipated or absorbed by the wall of the well bore when the drilling tool assembly touches or impacts it. The coefficients of friction shown in FIG. 6 are transverse dynamic 518, transverse static 519, axial dynamic 520, and axial static 521. The axial coefficients of friction refer to the friction experienced against the wall of the well bore as the drilling tool assembly moves with the axis of the well bore. The transverse coefficients of friction refer to the friction experienced against the wall of the well bore as the drilling tool assembly moves perpendicular to the axis or rotates. The defined well bore is shown in a tabular form 512, and may be viewed in a three-dimensional view 513.

After setting up the parameters for the drilling simulation, drilling with each drill bit is simulated using the same drilling tool assembly and in the same well bore. In this embodiment, the drilling operating parameters are selected as appropriate for the designs of the candidate drill bits. The drilling simulation includes the interaction of the cutting elements on the drill bit with the earth formation.

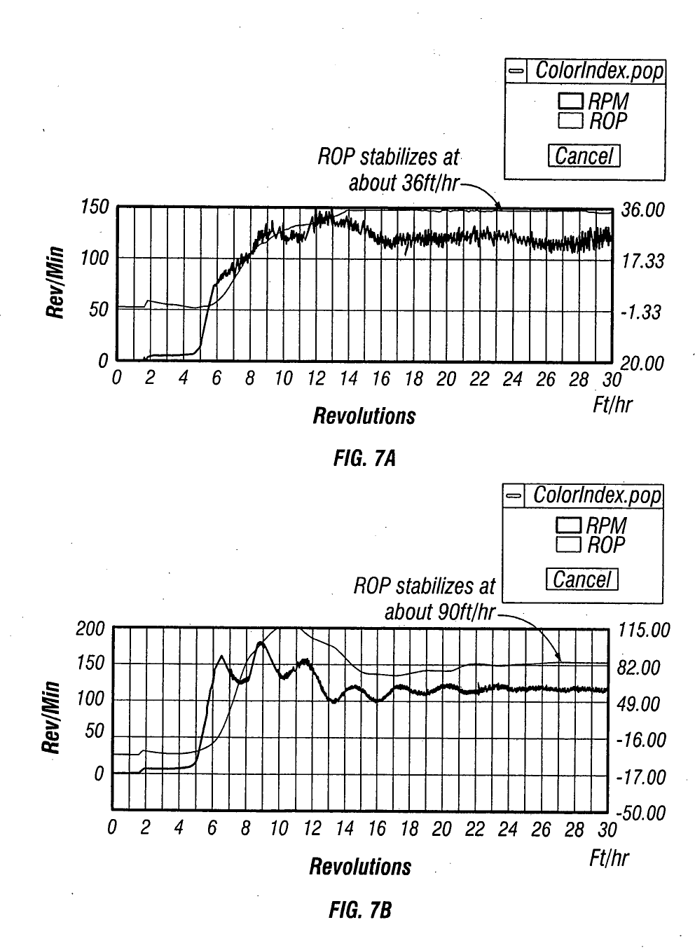

In this example, highest ROP and lowest vibrations are the selected drilling performance criteria. Upon completion of the drilling simulations, the outputs of the simulations are compared to the selected drilling performance criteria. Various outputs are provided from the drilling simulation to evaluate the drilling performance. Although additional drilling simulations may be run, only two of the potential solutions are shown for clarity. The two solutions examined in greater detail are candidate drill bits A and B. FIGS. 7A and 7B are outputs of the drilling simulations in accordance with an embodiment of the invention. Candidate drill bit B shown in FIG. 7B achieves a ROP of 90 feet/hour, which is much greater than the 36 feet/hour achieved by candidate drill bit A shown in FIG. 7A.

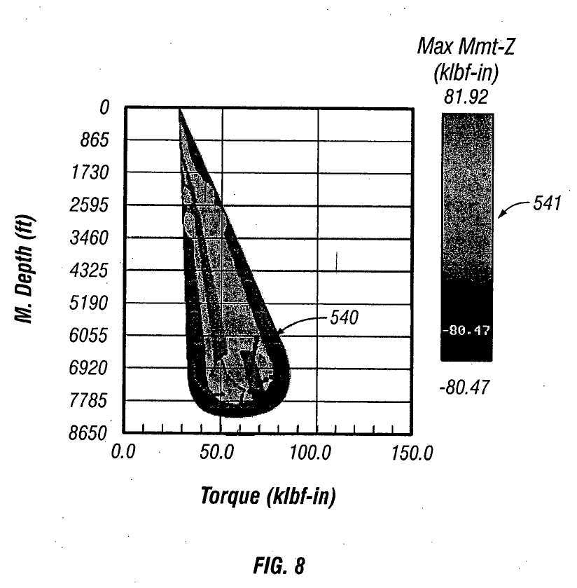

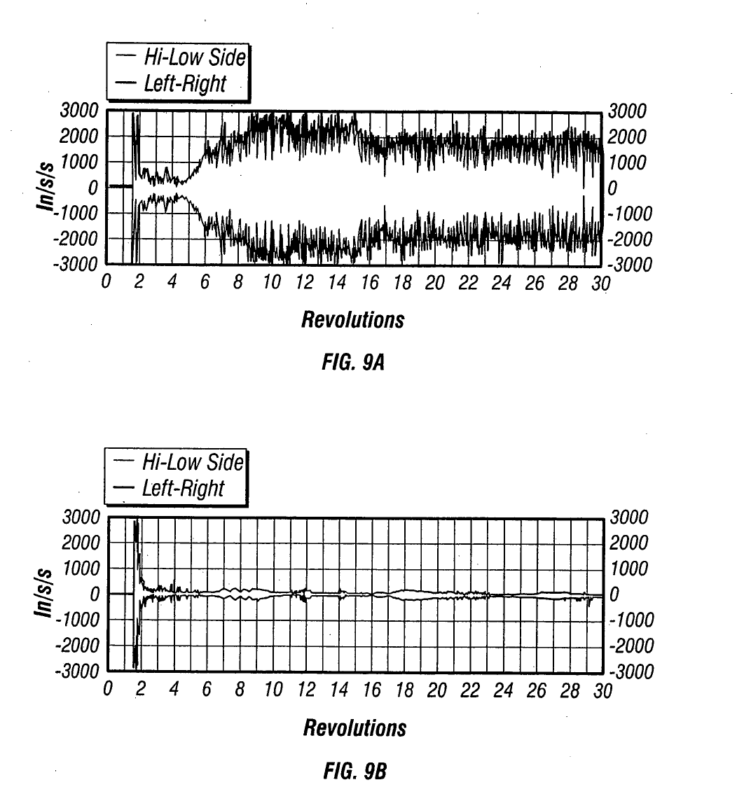

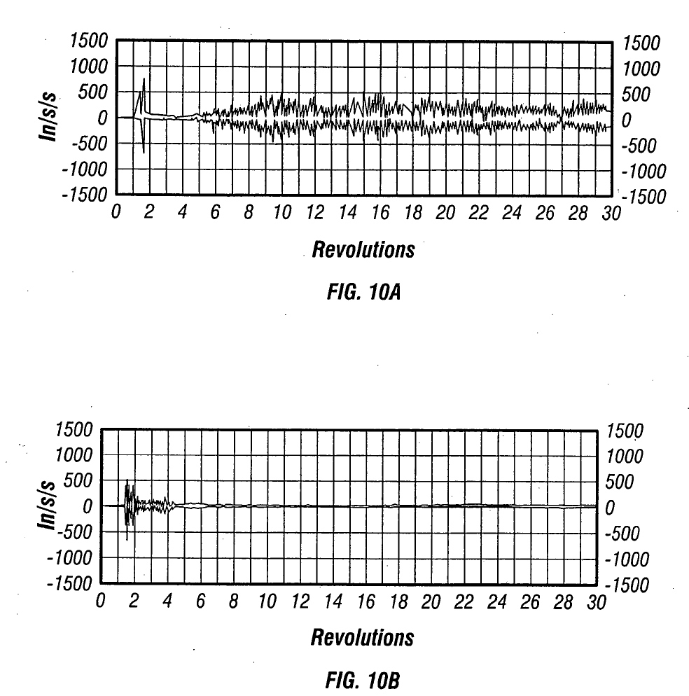

The other selected criterion is vibration of the drill bit, which influences the life span of the drill bit. FIG. 8 shows a three-dimensional graphical representation of candidate drill bit A in accordance with one embodiment of the invention. In one embodiment, FIG. 8 may be created from a frame of a moving display of the drilling simulation. The moving display may be a series of frames showing increments of the drilling simulation. Instability of the drill bit is indicated at 540 by a large bending moment. The experienced bending moment is quantified by a scale 541. The instability is confirmed by FIG. 9A, which displays the lateral vibration of candidate drill bit A. The lateral vibration is measured in inch/second 2. The span of large positive and negative acceleration indicates that the lateral vibration is problematic for candidate drill bit A. FIG. 9B displays the lateral vibration of candidate drill bit B, which is significantly lower than candidate drill bit B. FIGS. 10A and 10B display the axial vibrations experienced by candidate drill bits A and B, respectively. Candidate drill bit B experiences less axial vibrations than candidate drill bit A.

In the example above, candidate drill bit B satisfied the drilling performance criteria of high ROP and low vibrations. The use of candidate drill bit B is the selected solution for use in drilling the next well by the drilling operator. The preceding example is only for the purpose of illustrating the usage of a method in accordance with one embodiment of the present invention. One of ordinary skill in the art will appreciate that more or less drilling information can be obtained from different sources without departing from the scope of the invention.

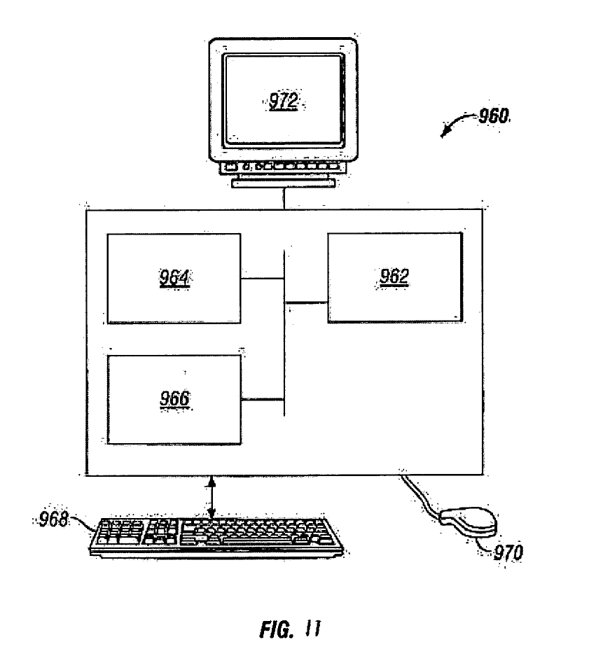

Aspects of embodiments of the invention, such as the collection and evaluation of drilling data and the performance of dynamic simulations, may be implemented on any type of computer regardless of the platform being used. For example, as shown in FIG. 11, a networked computer system (960) that may be used in an embodiment of the invention includes a processor (962), associated memory (964), a storage device (966), and numerous other elements and functionalities typical of today's computers (not shown). The networked computer (960) may also include input means, such as a keyboard (968) and a mouse (970), and output means, such as a monitor (972). The networked computer system (960) is connected to a local area network (LAN) or a wide area network (e.g., the Internet) (not shown) via a network interface connection (not shown). Those skilled in the art will appreciate that these input and output means may take other forms. Additionally, the computer system may not be connected to a network. Further, those skilled in the art will appreciate that one or more elements of the aforementioned computer (960) may be located at a remote location and connected to the other elements over a network.

Embodiments of the invention may provide one or more of the following advantages. Embodiments of the invention may be used to evaluate drilling information to improve drilling performance in a given drilling operation. Embodiments of the invention may be used to identify potential causes of drilling performance problems based on drilling information. In some cases, causes of drilling performance problems may be confirmed performing drilling simulations. Additionally, in one or more embodiments, potential solutions to improve drilling performance may be defined, validated through drilling simulations, and selected based on one or more selected drilling performance criteria. Further, methods in accordance with one or more embodiments of the present invention may provide predictions for the drilling performance of a selected drilling tool assembly.

Further, it should be understood that regardless of the complexity of a drilling tool assembly or the trajectory of the well bore in which it is to be constrained, the invention provides reliable methods that can be used to determine a preferred drilling tool assembly design for drilling in a selected earth formation under defined conditions. The invention also facilitates designing a drilling tool assembly having enhanced drilling performance, and may be used determine optimal drilling operating parameters for improving the drilling performance of a selected drilling tool assembly.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for creating a drilling profile, the method comprising:
obtaining drilling profile data;
performing a drilling simulation using at least a portion of said drilling profile data; and
recommending a modification to said drilling profile data.

2. A method for creating a drilling profile, the method comprising:
obtaining predicted drilling performance data from a drilling simulation of a base drilling profile; and
recommending a modification to the base drilling profile using said predicted drilling performance data.

3. A method for creating a drilling profile for a planned well, the method comprising:
obtaining field data from a field data source, wherein the field data comprises a base drilling profile and at least one well bore parameter for the planned well;
inputting the field data into a drilling simulation source;
obtaining drilling performance data from the drilling simulation source;
creating a different drilling profile; and
transferring the different drilling profile to a data source.

4. The method of claim 3, further comprising:
inputting the different drilling profile into the drilling simulation source; and
obtaining a predicted drilling performance for the different drilling profile.

5. The method of claim 4, further comprising:
comparing predicted drilling performance of the different drilling profile to at least one selected drilling performance criterion.

6. The method of claim 5, further comprising:
repeating the creating of the different drilling profile, the inputting of the different drilling profile into the drilling simulation source, the obtaining of the drilling performance data, and the comparing until the at least one predicted drilling performance parameter is within a selected range of the at least one selected drilling performance parameter.

7. The method of claim 3, further comprising:
transmitting the different drilling profile.

8. The method of claim 3, wherein the creating comprises adjusting the base drilling profile.

9. A method for modifying a base drilling profile for a planned well, the method comprising:
obtaining field data from a field data source, wherein the field data comprises the base drilling profile and at least one well bore parameter for the planned well;
inputting the field data into a drilling simulation source;
obtaining drilling performance data from the drilling simulation source;
determining a modification to the base drilling profile; and
transferring the modification to a data source.

10. The method of claim 9, further comprising:
modifying the base drilling profile to obtain a recommended drilling profile; and
transmitting the recommended drilling profile.

11. A method for creating a drilling profile for a planned well, the method comprising:
obtaining drilling profile data;
performing a drilling simulation using at least a portion of said drilling profile data; and
recommending a modification to said drilling profile data.

12. A method for demonstrating predicted drilling performance, the method comprising:
creating a recommended drilling profile, wherein the recommended drilling profile comprises a recommended drilling tool assembly;
performing a drilling simulation using the recommended drilling profile; and
displaying a graphical visualization of at least a portion of the recommended drilling tool assembly in a well bore drilling an earth formation.

13. The method of claim 12, further comprising:
displaying a graphical visualization of at least a portion of the base drilling tool assembly in the well bore drilling the earth formation.

14. The method of claim 13, further comprising:
displaying both graphical visualizations simultaneously, wherein an improved drilling performance of the recommended drilling profile is demonstrated relative to the base drilling profile.

15. A computer system for improving drilling performance of a drilling tool assembly comprising:
a processor;
a memory;
a storage device; and
software instructions stored in the memory for enabling the computer system under control of the processor, to:
obtain field data from a field data source, wherein the field data comprises a base drilling profile and at least one well bore parameter for the planned well;
input the field data into a drilling simulation source;
obtain drilling performance data from the drilling simulation source;
create a different drilling profile; and
transfer the different drilling profile to the storage device.

16. A method for demonstrating drilling performance on a computer graphical interface, the method comprising:
performing a drilling simulation of a drilling profile; and
displaying a three-dimensional graphical visualization of at least a portion of the drilling tool assembly in a well bore, wherein the three-dimensional graphical visualization comprises a drilling performance parameter selected from the group consisting of lateral vibration, axial vibration, torsional vibration, force on a component, rate of penetration, torque, weight on bit, and direction of path drilled.

17. The method of claim 16, wherein the three-dimensional graphical visualization is a moving display of at least a portion of the drilling tool assembly.

18. The computer system of claim 16, wherein the graphical visualization comprises a color scheme for the drilling tool assembly according to a drilling performance parameter.

19. The computer system of claim 16, wherein the drilling performance parameter is displayed as a plot of the drilling performance parameter with respect to a time.

20. A computer system for improving drilling performance of a drilling tool assembly comprising:
a processor;
a memory;
a display; and
software instructions stored in the memory for enabling the computer system under control of the processor, to:
perform a drilling simulation of a drilling profile; and
display a three-dimensional graphical visualization of at least a portion of the drilling tool assembly in a well bore, wherein the three-dimensional graphical visualization comprises a simulated drilling performance characteristic.
